(19) United States
(12) Patent Application Publication
(10) Pub. No.: US 2006/0092266 A1
(43) Pub. Date: May 4, 2006

(54) High resolution image management for devices using low bandwidth communication

(76) Inventor: Jeffrey A. Morgan, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/978,544

(22) Filed: Oct. 31, 2004

(51) Int. Cl. H04N 7/14

(52) U.S. Cl. 348/14.01

(57) ABSTRACT

A solution for image management for mobile devices is described which preserves a high resolution copy of the image while accommodating the throughput limitations of a multimedia low bandwidth network infrastructure, an example of which is the Multi-Media Messaging System used in cellular networks. Software in a mobile device sending an image generates a reference for accessing a high resolution copy of the image in network accessible high resolution image storage while sending a low resolution copy of the image with the reference over the multimedia low bandwidth communication path to a recipient device, and the high resolution copy of the image to the network accessible storage over a higher bandwidth communication path suitable for multimedia transfer. The recipient device accesses the high resolution copy of the image using the reference over a high bandwidth communication path suitable for multimedia transfer.

### CROSS-REFERENCE TO RELATED APPLICATION

This patent application is related to the patent application entitled “Spontaneous Sharing of Media Asset References,” having inventor Jeffrey A. Morgan and filed concurrently with this application, and which is hereby incorporated by reference.

### BACKGROUND

### Field of Invention

The invention relates generally to management of images transferred between at least one mobile device and a recipient device.

Today, many handheld mobile devices, some examples of which are cellular telephone devices, personal digital assistants, and other radio devices are equipped with embedded cameras and connect with a mobile network, some examples of which are 2.5g and 3g mobile networks. Handheld mobile devices are including cameras with higher resolution, for example the Verizon 710 features a 2 Mega-pixel camera, and market predictions are already stating that 3-4 Mega-pixel cameras will be embedded in cell phones over the next few years. However, the mobile network infrastructure does not provide adequate bandwidth for effective communication of multimedia, particularly images. A camera in a cell phone or other handheld device allows a user to share an experience captured in a still image or video segment, perhaps with annotation, with another cell phone user or an e-mail recipient. However, a mobile network infrastructure typically used for transferring images is the Multi-media Messaging System (MMS) which has a 100 Kilobit (Kb) bandwidth which is a low bandwidth for media applications but a high bandwidth for most mobile applications. The throughput rate for this bandwidth does not provide effective communication of images. The size of the images captured by 3-4 Mega-pixel cameras will be prohibitively large for direct use with MMS. Generally, any network over 500 Kb/sec is considered adequate for rich media, however, DSL/Cable modems at around 1-3 Mb/sec are the typical low-end for most media exchanges. Ten Megabits per second (10 Mb/sec) is the low end for a wired network (e.g., within a building) local area network (LAN). The IEEE 802.11 standards represent the high-end for wireless LANs.

A solution for management of image transfer that preserves access to a high resolution copy of the image while accommodating the throughput limitations of a low bandwidth communication path for multimedia purposes is highly desirable.

### SUMMARY OF INVENTION

The present invention provides one or more embodiments of solutions for high resolution image management for devices using multimedia low bandwidth communication. One or more embodiments of the solutions process a reference to a high resolution copy of an image that has been sent with a low resolution copy of the image using multimedia low bandwidth communication. The reference to the high resolution copy can be used to retrieve the high resolution copy by a device using higher bandwidth communication suitable for multimedia transfer.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is an architectural diagram of a system for high resolution image management for devices using multimedia low bandwidth communication in accordance with an embodiment of the present invention.

FIG. 2A is a functional block diagram of a system for high resolution image management for devices using multimedia low bandwidth communication operating on an image sending device in accordance with another embodiment of the present invention.

FIG. 2B is a functional block diagram of a system for high resolution image management for devices using multimedia low bandwidth communication operating on an image recipient device in accordance with another embodiment of the present invention.

FIG. 2C is a functional block diagram of a system for high resolution image management for devices using multimedia low bandwidth communication operating on a printer recipient device in accordance with another embodiment of the present invention.

FIG. 3 is a flow diagram of a computer-implemented method for high resolution image management for devices using multimedia low bandwidth communication from the perspective of a handheld mobile device sending an image in accordance with another embodiment of the present invention.

FIG. 4 is a flow diagram of a computer-implemented method for high resolution image management for devices using multimedia low bandwidth communication from the perspective of an image storage module receiving a request to store an image in accordance with another embodiment of the present invention.

FIG. 5 is a flow diagram of a computer-implemented method for high resolution image management for devices using multimedia low bandwidth communication from the perspective of a handheld mobile device receiving an image in accordance with another embodiment of the present invention.

FIG. 6 is a flow diagram of a computer-implemented method for high resolution image management for devices using multimedia low bandwidth communication from the perspective of an image storage module receiving a request to retrieve an image in accordance with another embodiment of the present invention.

The figures depict embodiments of the present invention for purposes of illustration only. One skilled in the art will readily recognize from the following discussion that other embodiments of the structures and methods illustrated herein may be employed without departing from the principles of the invention described herein.

### DETAILED DESCRIPTION OF THE DRAWINGS

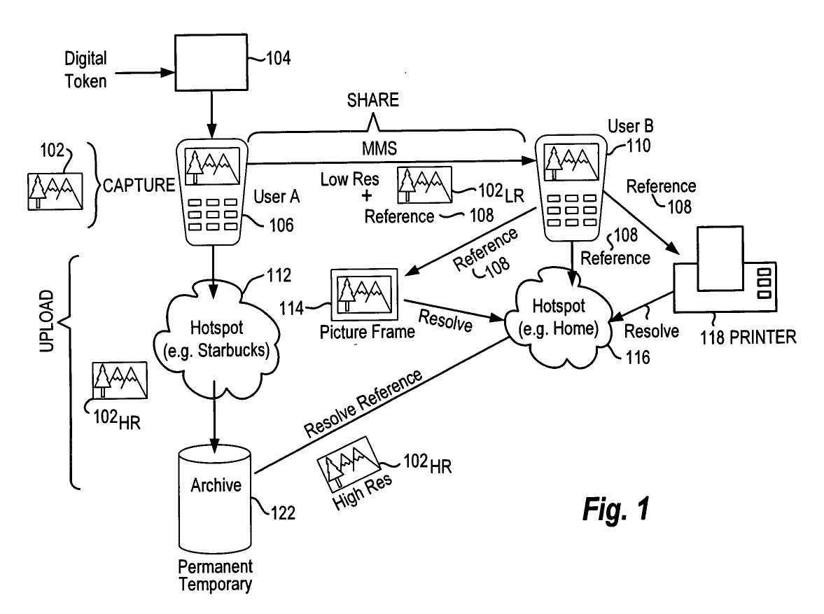

FIG. 1 is an architectural diagram of an example context 100 in which one or more embodiments of a system for high resolution image management for devices using multimedia low bandwidth communication can operate in accordance with an embodiment of the present invention. A handheld mobile device 106 illustrated as a cellular telephone associated with User A (hereafter referred to as “cell phone A” for ease of description) includes a camera (not shown) which captures at its highest resolution or the highest resolution requested by User A an image 102 which cell phone A stores locally. Cell phone A has at least two communication interfaces (not shown), one which allows it to communicate over the MMS provided by its cellular network with another handheld mobile device 110 associated with User B (hereafter referred to as “cell phone B” for ease of description) and another allowing a higher bandwidth connection via a Hotspot 112 (e.g., 802.11 based wireless access point at a coffee shop) to a World Wide Web accessible photo-repository archive service 122. In one example, the photo-repository 122 can store both still and moving images, for example, a home video. In this example, the photo-repository service 122 generated a digital token 104 (e.g., as part of the registration process for User A), including routing information and a communication protocol (e.g., http, ftp, email etc) for upload/download of information to the service 122 and identity data for User A from which authentication information can be generated. The digital token 104 can include the routing information and communication protocol as a Uniform Resource Identifier (URI). In one example, the identity data includes authentication credentials (e.g., those used with a cryptographic authentication protocol) necessary for storing and accessing data in the photo-repository. In one example, the authentication information is a secure (e.g., encrypted) access token. In one example, the digital token 104 is implemented as an Extensible Language Markup (XML) tag which can include one or more attributes.

The digital token 104 is stored securely in non-volatile memory on the device. Alternatively, the digital token 104 is generated as part of the initialization of the handheld mobile device, much like a SIM card in a cell phone, and is inserted into the device.

Consider that User A wants to share the image 102 with User B as she is walking down a street and transfer through MMS is only available. Software on cell phone A directs cell phone A's camera to generate a low resolution version 102_{LR} of the image 102 to be included with an MMS message, for example a thumbnail version, and a reference 108 for the high resolution copy 102_{HR} of the captured image 102. Software on cell phone A generates the reference 108 based on the data in the digital token 104. The reference 108 includes routing information to the photo-repository with an image identifier for the image 102 (e.g., a URI including the URI for the repository 122 extended by the image identifier) and an access or authentication token generated from the identity data in the digital token or from a combination of the identity data and a user entered personal identification number (PIN). In one example, the reference 108 is also implemented as an XML tag or XML dataset. In one example, the image identifier may be a name or other text entered by User A to identify the photo or that is generated typically by a digital camera for an index of images on cell phone A's camera. User A enters the coffee shop, and cell phone A's high bandwidth communication interface detects the Hotspot 112. Alternatively, User A could connect her cell phone A via a physical connection to a device (e.g., a personal computer, an all-in-one) having a higher bandwidth connection suitable for multimedia transfer. Similarly, the index of pictures including the low resolution copy 102_{LR} and its reference 108 can be stored on a removable medium such as a card with a magnetic strip or a memory stick that can be removed and plugged into another device connected via a higher bandwidth connection suitable for multimedia transfer. Using the higher bandwidth connection, the high resolution copy 102_{HR} and the reference 108 are transferred from cell phone A's memory to the photo-respository 122. The respository 122 determines User A's access rights based on the access token in the reference 108. If access is allowed, the repository 122 associates the reference 108 with the high resolution copy 102_{HR} of the image so that the image copy is accessible via a fully network resolvable identifier.

Assume User B likes the image 102 from the low resolution copy 102_{LR} and decides to display the high resolution copy 102_{HR} when he gets home. At home, User B has a higher bandwidth connection suitable for multimedia represented by Hotspot 116 which cell phone B detects. In this example, User B selects a URI link in the reference 108 sent in the MMS message with the low resolution copy 102_{LR} for accessing the image, and cell phone B responds by sending a request to the repository 122 for the high resolution copy 102_{HR} of the image. Cell phone B may also need to provide identity data, for example authentication credentials, to the repository 122 in order to access the image copy 102_{HR}. Assuming User B has access, the photo-repository 122 resolves the reference 108 to the storage location for the high resolution copy 102_{HR} and sends it to cell phone B for display. Further, User B decides to obtain a printout of the high resolution copy 102_{HR} from a printer 118 as well as a display of the high resolution copy 102_{HR} by a digital picture frame 114 or any imaging device connected to the Hotspot network 116. Cell phone B communicates the reference 108 to each of these devices 114, 118 via a peer network such as Bluetooth or IDRA or through an interface (for example a web form) provided by the imaging device over the Hotspot network 116. Each device 114, 118 sends the reference 108 (and identity data for User B if necessary) to the photo-repository 122 for resolution. The repository 122 resolves the reference 108, retrieves the high resolution copy 102_{HR} and sends it to the digital picture frame 114 which displays it in high resolution and the printer 118 which prints it at high resolution.

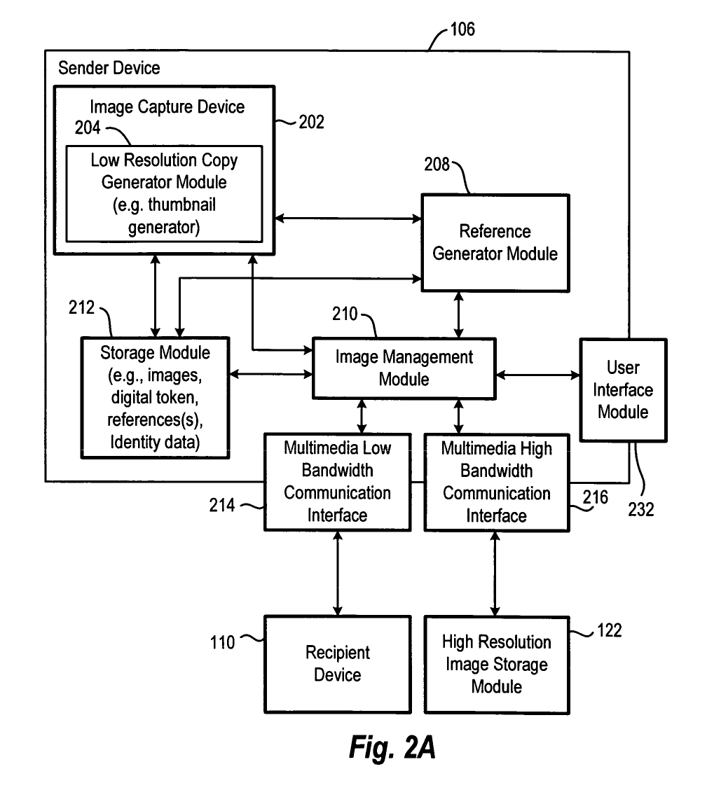

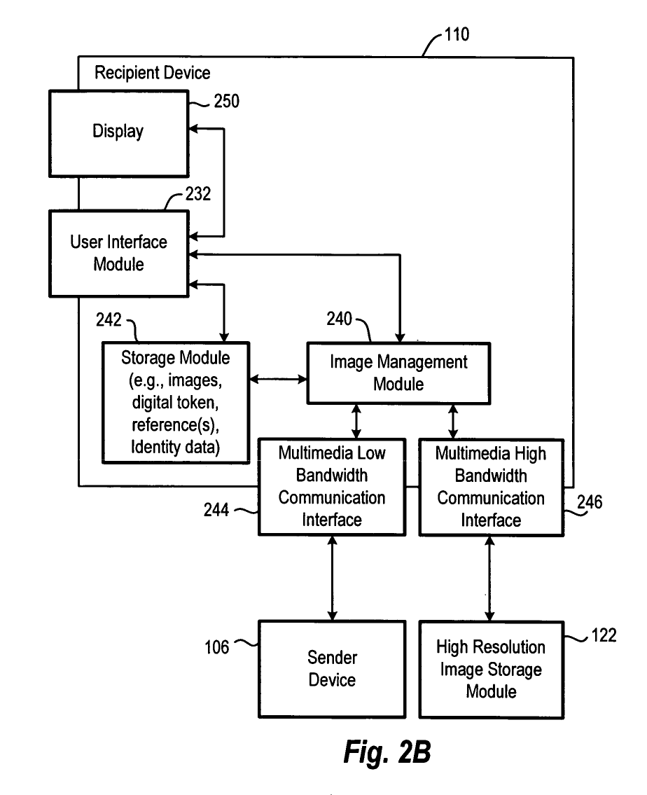

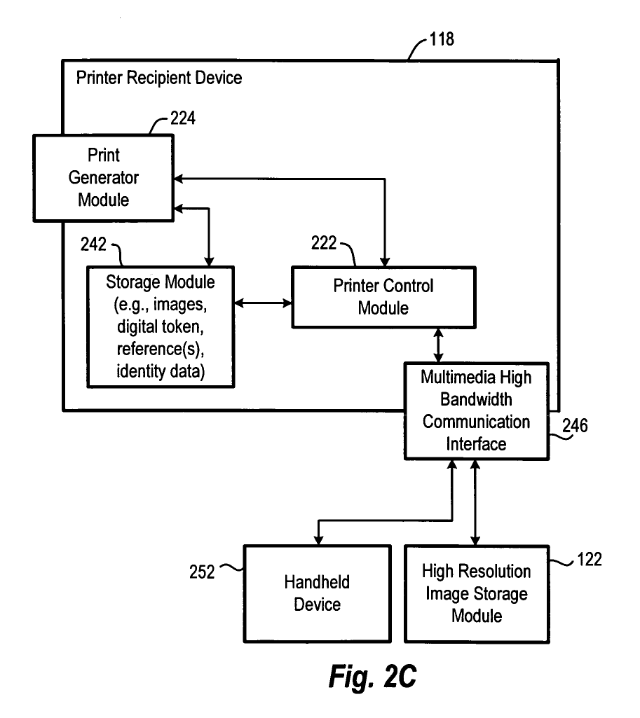

FIG. 2A is a functional block diagram of a system for high resolution image management for devices using multimedia low bandwidth communication operating on an image sending device 106 in accordance with another embodiment of the present invention. The system comprises an image management module 210 for controlling image transfer and which is communicatively coupled to a storage module 212 capable of storing images (e.g., 102_{LR} and 102_{HR}), a digital token (e.g., 104), reference(s) (e.g., 108), and identity data, an image capture device 202 including a low resolution copy generator module 204, a reference generator module 208, a user interface 232, a multimedia low bandwidth communication interface 214 and a multimedia high bandwidth communication interface 216. The image management module 210 coordinates processing among the illustrated modules 202, 204, 212, and 208 for the generation and transfer of a low resolution image copy (e.g., 102_{LR}) and a reference (e.g., 108) via the multimedia low bandwidth communication interface 214 responsive to user input processed via the user interface module 232 that an image is to be sent via a multimedia low bandwidth communication path (e.g., MMS) and the transfer of a high resolution image copy (e.g., 102_{HR}) via the multimedia high bandwidth communication interface 216.

The reference generator module 208 accesses the digital token (e.g., 104) stored in the storage module 212 to obtain a location identifier of a high resolution image storage module 122 and a preferred communication protocol for image transfer, which in one example is embodied in a URI, and identity data for a user associated with the sender device 106 (e.g., User A). The reference generator module 208 provides a network resolvable identifier for accessing the high resolution image. The generated reference also includes an image identifier. In this example, the module 208 retrieves the identifier for the image from an index of pictures generated by the image capture device 202. The generated reference includes routing information and a communication protocol for image transfer for the high resolution image storage module 122, an image identifier, and an access or authentication token generated from the user identity data in the digital token or the identity data in combination with a user entered authentication information such as a PIN or password.

As discussed above, in one example, the reference is an XML dataset including the access token, a URI of the high resolution image storage module 122, and the image identifier. In one example, the URI and the image identifier can be concatenated to form a URI which accesses a webpage including the high resolution copy of the image stored by the image storage module 122.

The image capture device 202 includes a low resolution copy generator module 204 which generates the low resolution image copy (e.g., 102_{LR}) which the image management module 210 sends with its associated generated reference over the multimedia low bandwidth communication interface 214 to a recipient device 110 (e.g., cell phone B).

Responsive to the image management module 210 being notified by the multimedia high bandwidth communication interface 216 of a connection with a high bandwidth communication path suitable for transferring multimedia, the image management module 210 retrieves from the storage module 212 and sends to the high resolution image storage module 122 the high resolution image copy and its reference. Upon a successful storage of the image by the high resolution image storage module 122 at a storage location associated with the reference, the image management module 210 can delete the high resolution image copy from the storage module 212 to free up memory space on the sender device 106 (e.g., handheld mobile device). A user of the sender device 106 can still access the high resolution copy of the image as long as the reference is still stored in the storage module 212 in the same manner as a recipient device (e.g., 110) would access the high resolution image.

Each of the modules illustrated in FIG. 2A or a portion thereof can be implemented in software suitable for execution on a processor and storage in a computer-usable medium, hardware, firmware or any combination of these. Computer-usable media include any configuration capable of storing programming, data, or other digital information. Examples of computer-usable media include various memory embodiments such as random access memory and read only memory, which can be fixed in a variety of forms, some examples of which are a hard disk, a disk, flash memory, or a memory stick.

FIG. 2B is a functional block diagram of a system for high resolution image management for devices using multimedia low bandwidth communication operating on an image recipient device 110 in accordance with another embodiment of the present invention. The system comprises an image management module 240 for controlling retrieval of a high resolution image copy associated with a reference received over a multimedia low bandwidth communication path and which is communicatively coupled to a storage module 242 capable of storing images (e.g., 102_{LR} and 102_{HR}), identity data (which can also be stored in a digital token) for a user (e.g., User B) associated with the recipient device 110 and reference(s) (e.g., 108), as well as to a user interface module 232 which processes user input and controls the display 250, a multimedia low bandwidth communication interface 244 though which the image management module 240 communicates with the sender device 106, and a multimedia high bandwidth communication interface 246 though which the image management module 240 communicates with the high resolution image storage module 122. Responsive to user input from the user interface module 232 indicating a request for the high resolution image copy (e.g., 102_{HR}) associated with a reference (e.g., 108) the image management module 240 retrieves from the storage module 242 and sends to the high resolution image storage module 122 the associated reference and identity data for User B, if necessary. Responsive to the reference being resolved by the high resolution storage module 122, the image management module 240 retrieves the high resolution image copy via the multimedia high bandwidth communication interface 246 from the high resolution image storage module 122, stores it in the storage module 242, and notifies the user interface module 232 that the image is available for display. The user interface module 232 causes the highest resolution image to be displayed on the display 250.

Each of the modules illustrated in FIG. 2B or a portion thereof can be implemented in software suitable for execution on a processor and storage in a computer-usable medium, hardware, firmware or any combination of these.

FIG. 2C is a functional block diagram of a system for high resolution image management for devices using multimedia low bandwidth communication operating on a printer recipient device in accordance with another embodiment of the present invention. In this example of a printer recipient device 118, a printer control module 222 is communicatively coupled to the storage module 242, the multimedia high bandwidth communication interface 246, and a print generator module 224. The printer control module 222 receives a reference for a high resolution image stored by the high resolution image storage module 122 from a handheld device 252 (e.g., sender device 106 or recipient device 110) which the printer control module 222 sends plus additional identity data if necessary from the storage module 242 to the high resolution image storage module 122 via the multimedia high bandwidth communication interface 246. If the reference is resolvable, the high resolution image storage module 122 sends the high resolution image to the printer control module 222 via the multimedia high bandwidth communication interface 246 which the printer control module 222 stores in the storage module 242. If the reference is not resolvable the image module 122 sends an appropriate message back instead. The printer control module 222 notifies the print generator module 224 that the image is available for printing, and the print generator module 224 outputs the high resolution print of the image.

Each of the modules illustrated in FIG. 2C or a portion thereof can be implemented in software suitable for execution on a processor and storage in a computer-usable medium, hardware, firmware or any combination of these.

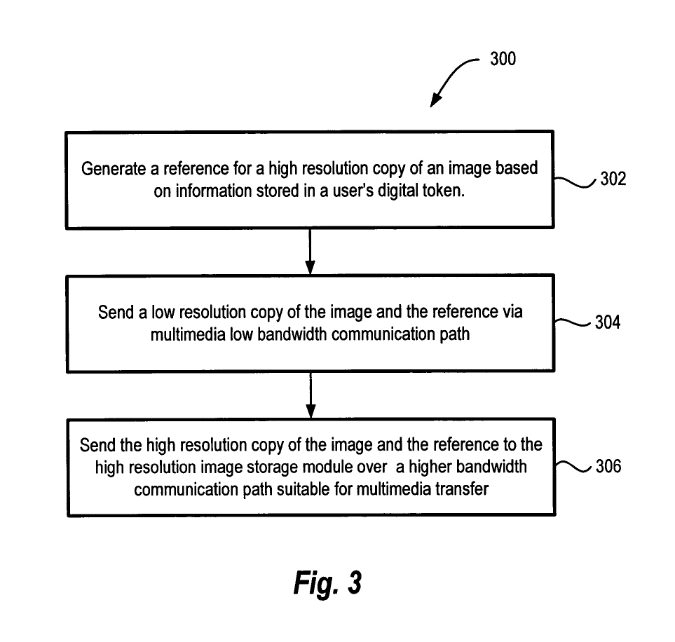

FIG. 3 is a flow diagram of a computer-implemented method 300 for high resolution image management for devices using multimedia low bandwidth communication from the perspective of a handheld mobile device sending an image in accordance with another embodiment of the present invention. For illustrative purposes only and not to be limiting thereof, the method embodiment 300 of FIG. 3 is discussed in the context of the system embodiment of FIG. 2A. The reference generator module 208 generates 302 a reference for a high resolution copy of an image based on information stored in a user's digital token. As discussed above, some of the information stored in the user's digital token includes routing information for the high resolution image storage module 122 (e.g., the web-based photo-repository service 122 of FIG. 1). Other information that can be included is identity data such as authentication credentials from which an access token can be generated and sent in the reference, for example as part of an XML dataset. The image management module 210 sends 304 a low resolution copy of the image and the reference via a multimedia low bandwidth communication path, and sends 308 the high resolution copy of the image and the reference to the high resolution image storage module 306 over a higher bandwidth communication path suitable for multimedia transfer.

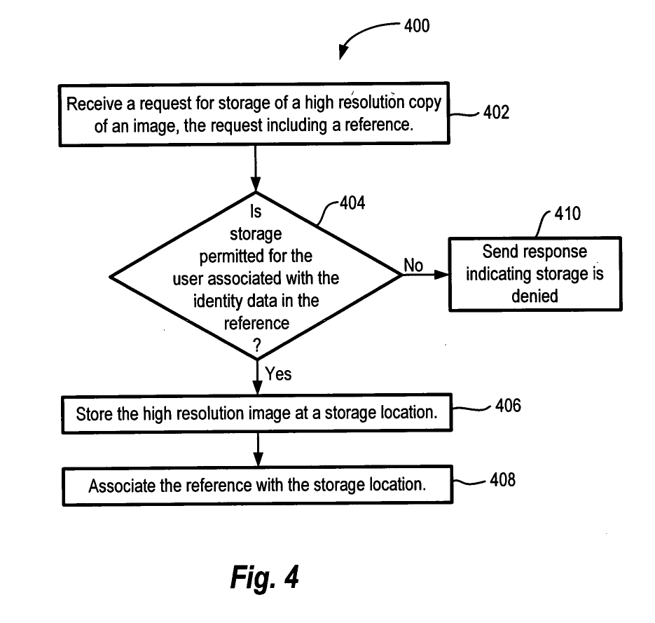

FIG. 4 is a flow diagram of a computer-implemented method for high resolution image management for devices using multimedia low bandwidth communication from the perspective of an image storage module receiving a request to store an image in accordance with another embodiment of the present invention. For illustrative purposes only and not to be limiting thereof, the method embodiment 400 of FIG. 4 is discussed in the context of the system embodiment 100 of FIG. 2A. The high resolution image storage module 122 receives 402 a request for storage of a high resolution copy of an image, the request including a reference including identity data (e.g., authentication information). The high resolution image storage module 122 determines 404 whether storage is permitted for the user associated with the authentication information. Responsive to storage not being permitted, the high resolution image storage module 122 sends 410 a response indicating storage is denied. Responsive to storage being permitted, the high resolution image storage module 122 stores 406 the high resolution image at a storage location, and associates 408 the reference with the storage location.

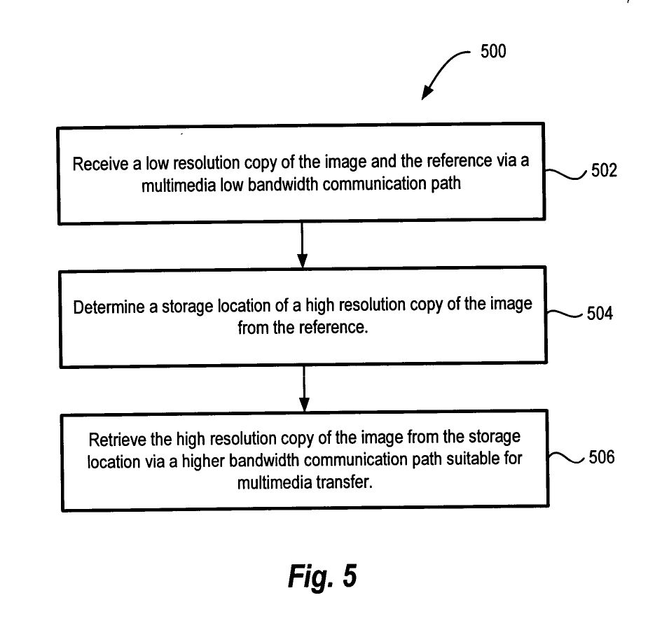

FIG. 5 is a flow diagram of a computer-implemented method for high resolution image management for devices using multimedia low bandwidth communication from the perspective of a handheld mobile device receiving an image in accordance with another embodiment of the present invention. For illustrative purposes only and not to be limiting thereof, the method embodiment 500 of FIG. 5 is discussed in the context of the system embodiment 100 of FIG. 2B. The image management module 240 receives 502 a low resolution copy of the image and the reference via a multimedia low bandwidth communication path, determines 504 a storage location of a high resolution copy of the image from the reference, and retrieves 506 the high resolution copy of the image from the storage location via a higher bandwidth communication path suitable for multimedia transfer.

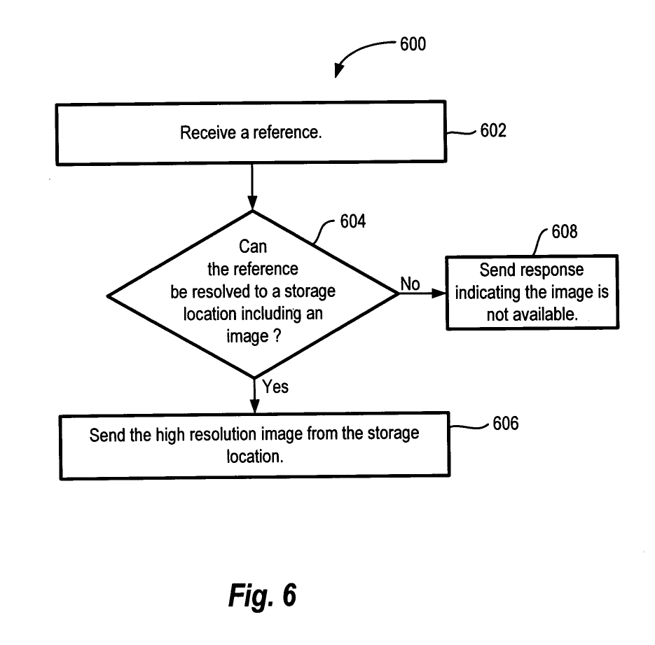

FIG. 6 is a flow diagram of a computer-implemented method for high resolution image management for devices using multimedia low bandwidth communication from the perspective of an image storage module receiving a request to retrieve an image in accordance with another embodiment of the present invention. For illustrative purposes only and not to be limiting thereof, the method embodiment 600 of FIG. 6 is discussed in the context of the system embodiment 100 of FIG. 2B. The high resolution image storage module 122 receives 602 a reference and determines 604 whether the reference can be resolved to a storage location including an image. Furthermore, the image storage module 122 can require that additional criteria be satisfied before allowing access to the image, for example, verification of authentication information associated with the request including the reference. Responsive to the reference not being resolved, the high resolution image storage module 122 sends 608 a response indicating the image is not available. Responsive to the reference being resolved, the high resolution image storage module 122 sends 606 the high resolution image from the storage location.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the hereto appended claims. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Of course, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A system for high resolution image management for devices using multimedia low bandwidth communication comprising:
a reference generator module for generating a reference for a high resolution copy of an image for storage in a high resolution image storage module;
a low resolution copy generator module for generating a low resolution copy of the high resolution image; and
an image management module communicatively coupled to the reference generator module for receiving the reference and communicatively coupled to the low resolution copy generator module for receiving the low resolution copy wherein the image management module sends the low resolution copy of the image and the reference via a multimedia low bandwidth communication path and sends the high resolution copy of the image and the reference to the high resolution image storage module over a higher bandwidth communication path suitable for multimedia transfer.

2. The system of claim 1 wherein the reference generator module generates the reference as an Extensible Markup Language (XML) dataset including a Uniform Resource Identifier for accessing the high resolution copy of the image.

3. The system of claim 1 wherein the high resolution image storage module stores the received high resolution copy of the image at a storage location and associates the reference with the storage location of the high resolution copy of the image.

4. A system for high resolution image management for devices using multimedia low bandwidth communication comprising:
a multimedia low bandwidth communication interface;
a multimedia higher bandwidth communication interface;
an image management module being communicatively coupled to the multimedia low bandwidth communication interface and to the multimedia high bandwidth communication interface;
wherein the image management module receives a low resolution copy of an image and a reference including an identifier of a high resolution image storage module and an identifier of a high resolution copy of the image stored by the high resolution image storage module via the multimedia low bandwidth communication interface from a multimedia low bandwidth communication path; and
the image management module retrieves the high resolution copy of the image from the high resolution image storage module via the multimedia higher bandwidth communication interface from a higher bandwidth communication path suitable for multimedia.

5. A method for high resolution image management for devices using multimedia low bandwidth communication comprising:
generating a reference for a high resolution copy of an image based on an identifier of a high resolution image storage module and an image identifier;
sending a low resolution copy of the image and the reference via a multimedia low bandwidth communication path; and
sending the high resolution copy of the image and the reference over a higher bandwidth communication path suitable for multimedia transfer to the high resolution image storage module.

6. The method of claim 5 wherein generating a reference for the high resolution copy of the image further comprises generating the reference as an Extensible Markup Language (XML) dataset including a Uniform Resource Identifier for accessing the high resolution copy of the image.

7. The method of claim 5 further comprising storing the high resolution copy of the image at a storage location by the high resolution image storage module and associating the reference with the high resolution copy of the image.

8. A method for high resolution image management for devices using multimedia low bandwidth communication comprising:
receiving a low resolution copy of an image and a reference including an identifier of a high resolution image storage module and an identifier of a high resolution copy of the image stored by the high resolution image storage module via a multimedia low bandwidth communication path;
determining a storage location of the high resolution copy of the image from the reference; and
retrieving the high resolution copy of the image from the storage location via a higher bandwidth communication path suitable for multimedia transfer.

9. A computer usable medium comprising instructions for causing a processor to execute a method for high resolution image management for devices using multimedia low bandwidth communication, the method comprising:
generating a reference for a high resolution copy of an image including a network resolvable identifier;
sending a low resolution copy of the image and the reference via a multimedia low bandwidth communication path; and
sending the high resolution copy of the image and the reference over a higher bandwidth communication path suitable for multimedia transfer to the high resolution image storage module.

10. The computer usable medium of claim 9 wherein generating a reference for a high resolution copy of an image based on an identifier of a high resolution image storage module and an image identifier further comprises generating the reference as an Extensible Markup Language (XML) dataset including a Uniform Resource Identifier for accessing the high resolution copy of the image.

11. A computer usable medium comprising instructions for causing a processor to execute a method for high resolution image management for devices using multimedia low bandwidth communication, the method comprising:
receiving a low resolution copy of an image and a reference including an identifier of a high resolution image storage module and an identifier of a high resolution copy of the image stored by the high resolution image storage module via a multimedia low bandwidth communication path;
determining a storage location of a high resolution copy of the image from the reference; and
retrieving the high resolution copy of the image from the storage location via a higher bandwidth communication path suitable for multimedia transfer.

12. A system for high resolution image management for devices using multimedia low bandwidth communication comprising:
means for generating a reference for a high resolution copy of an image for storage in a high resolution image storage module;
means for generating a low resolution copy of the high resolution image; and
means for image management communicatively coupled to means for generating a reference for receiving the reference and communicatively coupled to the means for generating a low resolution copy for receiving the low resolution copy, wherein the means for image management sends the low resolution copy of the image and the reference via a multimedia low bandwidth communication path, and sends the high resolution copy of the image and the reference to the high resolution image storage module over a higher bandwidth communication path suitable for multimedia transfer.

13. The system of claim 12 wherein the means for generating a reference generates the reference as an Extensible Markup Language (XML) dataset including a Uniform Resource Identifier for accessing the high resolution copy of the image.

14. The system of claim 12 wherein the high resolution image storage module stores the received high resolution copy of the image at a storage location and associates the reference with the high resolution copy of the image.

15. A system for high resolution image management for devices using multimedia low bandwidth communication comprising:
means for interfacing with a multimedia low bandwidth communication path;
means for interfacing with a multimedia higher bandwidth communication path;
means for image management being communicatively coupled to the means for interfacing with a multimedia low bandwidth communication path and to the means for interfacing with a multimedia higher bandwidth communication path;
wherein the means for image management receives a low resolution copy of an image and a reference including an identifier of a high resolution image storage module and an identifier of a high resolution copy of the image stored by the high resolution image storage module via the means for interfacing with a multimedia low bandwidth communication path; and
the means for image management retrieves the high resolution copy of the image from the storage location via the means for interfacing with a multimedia higher bandwidth communication path.
